(19) United States
(12) Patent Application Publication
(10) Pub. No.: US 2008/0101693 A1
(43) Pub. Date: May 1, 2008

(54) VIDEO IMAGE BASED TRACKING SYSTEM FOR IDENTIFYING AND TRACKING ENCODED COLOR SURFACE

(75) Inventors: Hay Young, New Territories (HK); Alex Tang, Kowloon (HK); Frederick Ng, New Territories (HK)

Correspondence Address: ROGER PITT;KIRKPATRICK & LOCKHART PRESTON GATES ELLIS LLP, 599 LEXINGTON AVENUE, 33RD FLOOR, NEW YORK, NY, 10022-6030, US

(73) Assignee: INTELLIGENCE FRONTIER MEDIA LABORATORY Ltd, Shatin (HK)

(21) Appl. No.: 11/924,038

(22) Filed: Oct. 25, 2007

Related U.S. Application Data
(60) Provisional application No. 60/863,060, filed on Oct. 26, 2006.

(51) Int. Cl. G06K 9/46

(52) U.S. Cl. 382/165; 382/166

(57) ABSTRACT

A video image based tracking method and apparatus for identifying and tracking encoded color surface. Encoded color patterns are integrated with tangible objects such as tangible toys or tangible input objects so that they can be used as a tangible input device for a computing system to control virtual multimedia objects and trigger game interactions. The color pattern within the field of sight of a video image capturing device is identified and tracked and by a computing system. Method to configure the color pattern is included. A great number of encoded patterns can be created. Method to identify the encoded color pattern is included. Method to estimate the 6-DOF (degree-of-freedoms) orientation and coordinates information of the tangible object with encoded color pattern is included. Multiple encoded color patterns can be identified and tracked simultaneously. Tangible toys or tangible input objects configured with encoded color patterns can retain their color identity while capable of being identified and their 6-DOF orientation and coordinates tracked by the computing system.

### CROSS-REFERENCE TO A RELATED APPLICATION

This application claims the benefit of Provisional Patent Application No. 60/863,060 filed Oct. 26, 2006.

### STATEMENT REGARDING FEDERALLY SPONSORED RESEARCH OR DEVELOPMENT

(Not applicable.)

### FIELD OF THE INVENTION

This invention relates to the identification and tracking of encoded patterns on tangible objects.

### BACKGROUND OF THE INVENTION

Both tangible toys and computer games have their own distinctive play values. On the one hand a tangible toy provides a full-scale perceptual experience of touch, visual, auditory, taste and smelling, which are vital for children's psychological and physiological development. On the other hand, virtual interactions and multimedia simulations in computer games can significantly enrich children's experiences and inspire their imaginations.

Children love both computer games and tangible toys. To enrich tangible toys with imaginary multimedia simulations and virtual interactions is at the same time challenging and rewarding, since it will combines the play values and learning values in real toys and virtual computer games. However, the mixing of reality and virtual reality is not viable if we still rely on control devices such as keyboard, mouse, joysticks or joypads in computer games. Moreover, younger children may find it difficulty to handle such input devices due to their physiological constraints to control the devices and their cognitive power to associate the control of the mouse, keyboard, joystick or joypad and the events in the virtual game.

Video image based tracking methods such as shape matching and object recognition can give accurate tracking readings and allow detecting multiple objects within a field of sight of an image capturing device of a computing system. However, shape matching and object recognition are computational heavy and not robust enough to identify an individual toy from a group of toys mingling closely together as that often happens in the case of toy playing.

Fiducial landmarks or markers are used in recent years for scene or object recognition. In video image based marker tracking systems of prior art, designated markers, usually with a black and white or gray scale pattern in the center region of the marker, are capable of being recognized by the computing system with an image capturing device. These prior arts are based on a luminous method and processed by gray scale images for its simplicity. However, the drawbacks of these prior arts are: the markers are at odd with the design of the toy object. The black and white markers will strip away the colorful property and unique pattern design of the toy object. Usually a toy object is colorful and has its own decorative pattern. Moreover, the dependence on gray scale image processing limits the number of data carried by each marker and thus the total number of markers which can be used.

The limitations in the video image based marker tracking systems of prior arts have limited their applications in mixing tangible toys with virtual computer simulations and game interactions.

### SUMMARY OF THE INVENTION

The real challenge obviously lies on transforming tangible toys into tangible input devices for the computing system or game consoles. A new mechanism which has the capability of tracking multiple tangible toys or tangible input objects is required.

The present invention provides a novel video image based tracking system for identifying and tracking tangible toys, which can transform tangible toys with bearing a suitably colorful pattern into tangible input devices for a computing system.

In a first aspect the present invention provides a video image based tracking system for identifying and tracking an encoded color surface. An encoded color surface means a surface of a tangible object which is integrated with an encoded color pattern. An encoded color pattern means a color pattern where data is encoded inside the pattern and capable of being deducted from its video image captured by a computing system. A preferred method and other practicable methods to configure an encoded color pattern are included. The possibility of using different colors for the same pattern significantly increases the data bits. Thus it significantly increases the number of different encoded color patterns which can be generated.

Further, a second aspect of the present invention provides methods of identifying an encoded color patterns within a field of sight of an image capturing device. The methods include steps of image processing of the captured image in order to detect a designated color pattern and deduce the identity of the encoded color pattern from its color data bits. An error checking method is included to ensure the correctness of the encoded data. Multiple encoded color patterns can be identified simultaneously.

Still further, a third aspect of the present invention provides methods of tracking the movement and orientation of the above-mentioned encoded color pattern within a field of sight of an image capturing device. The methods include estimating the 6-DOF (degree-of-freedoms) orientation and coordinates of the encoded color pattern by calculating the 2-dimensional coordinates of the pattern. Multiple encoded color patterns can be tracked simultaneously.

Further, a fourth aspect of the present invention provides methods of configuring an encoded color pattern onto the object surface of a tangible toy or tangible input object. The encoded color pattern is integrated into the colors and patterns of said tangible toy or tangible input object. The surface of said tangible toy or tangible input object becomes an encoded color surface. The identity of said tangible toy or tangible input object within a field of sight of an image capturing device is capable of being deduced by a computing system.

Still further, a fifth aspect of the present invention provides a computer readable medium having program instructions to a computing system for detecting and identifying the object identity of said tangible toy or tangible input object configured with an encoded color pattern.

Still further, a sixth aspect of the present invention provides a computer readable medium having program instructions to a computing system for triggering input commands which associate the said object identity with a virtual object in a computing program running through a computing system. The said tangible toy or tangible input object is thus augmented to become a tangible input device for a computing system.

Further, a seventh aspect of the present invention provides methods of configuring an encoded color pattern onto the object surface of a tangible toy or tangible input object. The encoded color pattern is integrated into the colors and patterns of the said tangible toy or tangible input object. The surface of said tangible toy or tangible input object becomes an encoded color surface. The tangible toy or tangible input object may be moved laterally and vertically, rotated and tilted by the users. The 6-DOF orientation and coordinates of said tangible toy or tangible input object within a field of sight of an image capturing device is capable of being estimated by the computing system.

Still further, an eighth aspect of the present invention provides a computer readable medium having program instructions to a computing system for detecting and estimating the 6-DOF orientation and coordinates of said tangible toy or tangible input object configured with an encoded color pattern.

Still further, a ninth aspect of the present invention provides a computer readable medium having program instructions to a computing system for triggering input commands which associates the information of 6-DOF orientation and coordinates of said tangible toy or tangible input object with a virtual object in a computing program running through a computing system. The said tangible toy or tangible input object is thus augmented to become a tangible input device for a computing system.

Further, a tenth aspect of the present invention provides a computing system containing a control system that triggers input commands of a computing program running through a computing system. A video image capturing device is includes. Logics for identifying and tracking the movement and orientation of an encoded color pattern are included. Logics for triggering an input command in response to the object identification and 6-DOF orientation and coordinate tracking are included.

Further, an eleventh aspect of the present invention provides an interface comprised of a computing system and tangible input devices. The computing system includes a video image capturing device. The tangible input devices are tangible toys and tangible input objects configured with encoded color patterns to be placed within a field of sight of the video image capturing device. The identities of different tangible input devices are capable of being detected, and their movement and orientation tracked by the computing system in order to trigger designated input commands to a computing program running through the computing system.

Other aspects and advantages of the invention will be set forth in the following detail description, illustrated by accompanying drawings, or in part will become obvious from the description, or may be learned by practice of the invention.

### BRIEF DESCRIPTION OF THE DRAWINGS

Embodiments of the present invention, with further advantages thereof, will now be described with reference to the accompanying drawings:

FIG. 1 is a schematic view of one embodiment of video image based tracking system of the present invention.

FIG. 2 is a diagram showing one embodiment of an encoded color pattern, in this case a pattern having a square shape, useful in the video image based tracking system shown in FIG. 2.

FIGS. 3A, 3B and 3C are diagrams showing variations of embodiment of the encoded color pattern in square shape.

FIGS. 4A and 4B are diagrams showing variations of embodiment of the encoded color pattern in rectangle shape.

FIGS. 5A and 5B are diagrams showing variations of embodiment of the encoded color pattern in circle shape.

FIGS. 6A and 6B are diagrams showing variations of embodiment of the encoded color pattern in star shape.

FIG. 7A is a diagram showing the encoded color pattern of one embodiment where the data is encoded in the inner region.

FIG. 7B is a diagram showing the encoded color border of the encoded color pattern of FIG. 7A.

FIG. 7C is a diagram showing the inner encoded pattern of the encoded color pattern of FIG. 7A.

FIG. 7D is another diagram showing a variation of the inner encoded pattern of FIG. 7C.

FIG. 7E is another diagram showing a variation of the inner encoded pattern of FIG. 7C.

FIG. 8 is a schematic view showing encoded color patterns integrated with the color surfaces of tangible objects.

FIG. 9A is a diagram showing an encoded color pattern comprised of three encoded color patterns.

FIG. 9B is a schematic view of a toy car with the encoded color pattern shown in FIG. 9A.

FIG. 10 is a schematic view of the tracking system which detects and tracks the encoded color patterns on tangible toys and tangible input objects.

FIG. 11A is a schematic view showing a user using the apparatus. In one embodiment, a toy dinosaur and a toy car with encoded color patterns are used as tangible input devices.

FIG. 11B is a schematic view showing the result displaying on the screen of the computing system.

FIG. 12A is a schematic view showing a user is moving upward a toy car with encoded color pattern.

FIG. 12B is a schematic view showing the result displaying in computing system that the corresponding virtual car is moving upward.

FIG. 13A is a schematic view showing a user is tilting a toy car with encoded color pattern.

FIG. 13B is a schematic view showing the result displaying in computing system that the corresponding virtual car is tilting.

FIG. 14 is a flow chart diagram showing the method of detecting and tracking encoded color patterns in shape of a quadrangle.

FIG. 15 is a flow chart diagram showing the method of detecting and tracking encoded color patterns in other shapes.

### DESCRIPTION OF THE PREFERRED EMBODIMENTS

In the following descriptions, numerous specific details will now be made to explain, with reference to the accompanying drawings, the preferred embodiments of the present invention.

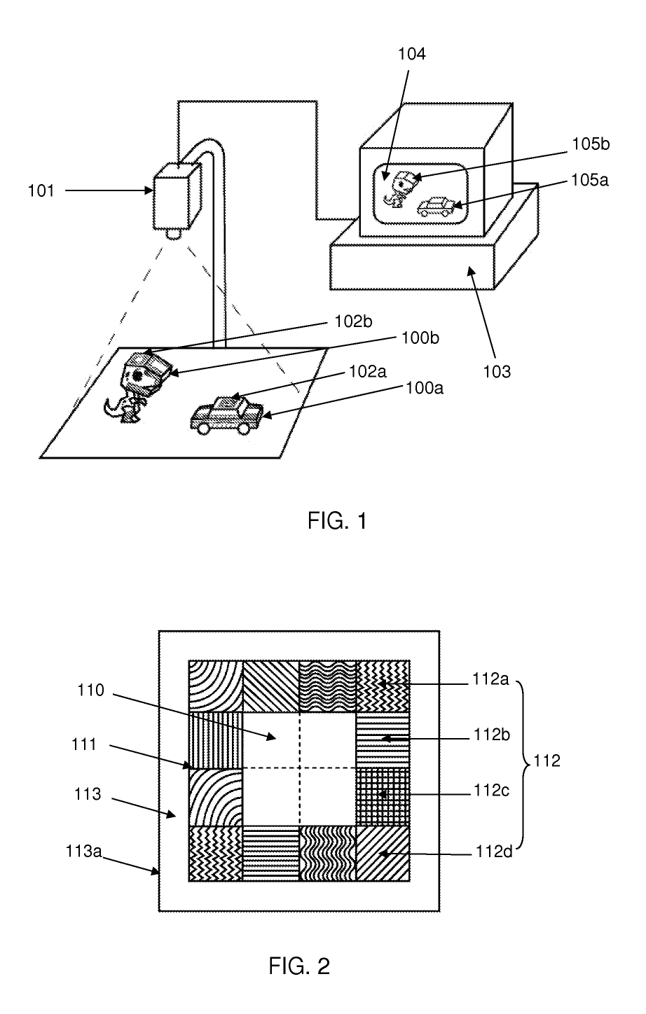

FIG. 1 is a schematic view of a preferred setup of the video image based tracking system of the present invention, capable of identifying and tracking encoded color surfaces on tangible objects such as tangible toys and tangible input objects, under normal living environment. An encoded color surface hereafter means the surface of a tangible object which is integrated with an encoded color pattern. An encoded color pattern hereafter means a color pattern where data is encoded inside the pattern and capable of being deducted from the image captured by a computing system.

The tracking system comprises encoded color patterns 102a and 102b, which are integrated with the surfaces of respective tangible objects, an image capture device 101 and a computing system 103. The tangible objects, in the embodiments shown in the drawings comprise a toy car 100a and a toy dinosaur 100b. A wide variety of other toys or other tangible objects may be employed, as will be apparent to one skilled in the art. The computing system is configured with an image capturing device 101 and a display system 104. The image capturing device 101 can be a CMOS image sensor with a lens. Alternatively, it can be any image capturing device capable of detecting the encoded color patterns 102a and 102b, for instant, a webcam, a digital camera, a camera coupled with a digitizer, or an array of charged coupled devices (CCDs), etc. The image capturing device 101 is targeting at the encoded color patterns 102a and 102b such that the encoded color patterns 102a and 102b are within the field of sight of the image capturing device 101. The image capturing device 101 can operate in a normal living environment, sufficiently lighted by normal daylight or artificial light. Automatic calibration of the white balance by the image capturing device 101 can be employed for adapting the image sensor to the color temperature of the light source.

The tracking system of the present invention is capable of determining the pose of an encoded color pattern which is captured from an image capture device 101. After going through a decoding process, the object identity of the encoded color patterns 102a and 102b configured on the tangible objects are identified and their 6-DOF (degree-of-freedom) orientation and coordinates within the field of sight of an image capture device 101 are estimated.

The information of object identities and the 6-DOF orientation and coordinates of encoded color patterns 102a and 102b are used as input commands for controlling the virtual objects 105a and 105b displayed on a display system 104, generated by a computing program running on a computing system 103. The virtual objects 105a and 105b represent tangible objects configured with encoded color patterns 102a and 102b respectively. When a user places two tangible objects configured with encoded color patterns 102a and 102b, in this embodiment a toy car 100a and a toy dinosaur 100b, within the field of sight of an image capture device 101, a virtual car and a virtual dinosaur appear on the screen of the display system 104. When the user moves the said tangible objects within the field of sight of an image capture device 101, the virtual car 105a and the virtual dinosaur 105b will move in accordance with the change of 6-DOF orientation and coordinates of the said tangible objects configured with encoded color patterns 102a and 102b. Hence, a tangible object is transformed into a tangible input device for triggering input commands to a program running on a computing system.

FIG. 2 is a diagram showing the encoded color pattern of one embodiment of the present invention. The encoded color pattern shown is configured in shape of a square, comprising an outer boundary 113 in a color or colors of high lightness, an encoded color border 111 in blocks of colors of high saturation and low lightness, and an inner region 110. If desired, light-colored outer boundary 113 can be demarked by a dark peripheral line 113a. The colored blocks of encoded color border 111 can be high saturation, and relatively darker colors evenly coated so that individual color blocks have a homogenous appearance. In FIG. 2, the colored blocks are represented by black-and-white pattern blocks such as block 112a, 112b, 112c and 112d. The sharp luminance contrast between outer boundary 113 and encoded color border 111 provides a clear partition for extracting the region inside the outer boundary.

The graphic patterns of cross-hatching, waves and the like shown in black-and-white pattern blocks such as blocks 112a, 112b, 112c and 112d are used to indicate different colors, or differences in coloring that the computer can recognize. Such graphic patterning is not intended to be employed on the tangible objects. However, the graphic patterning shown, or other suitable graphic patterning or shading could be so used in addition to, or in place of, the differential color patterning that is here described, if such usage would be helpful to the objectives of the invention.

The color blocks such as blocks 112a, 112b, 112c and 112d have contrasting color characteristics enabling the computer to clearly recognize and distinguish individual colored blocks. The color of each color block such as blocks 112a, 112b, 112c and 112d is selected from a certain number of prescribed colors. For example, the color blocks such as blocks 112a, 112b, 112c and 112d are selected from a combination of four colors such as red, blue, green, black. The adjacent color blocks such as blocks 112a, 112b, 112c and 112d can be in different colors or the same color.

In another embodiment of the invention (not shown) the outer boundary 113 is relatively dark and colored blocks such as blocks 112a, 112b, 112c and 112d are in blocks of relatively light colors.

Some exemplary colors for light-colored outer boundary 113 include white, yellow, light tints of blue, pink and green and light grey. Some exemplary colors for colored blocks 112a, 112b, 112c and 112d include strong or relatively saturated tints of red, orange, green, blue and purple as well as dark shades of grey and black. In one example, colored block 112a is blue, colored block 112b is orange, colored block 112c is green and colored block 112d is red, all being deep, saturated colors with modest dark shading. Many other color schemes will be apparent to those skilled in the art in light of this disclosure.

The outer boundary 113 provides a light color space between the encoded color border 111 and the background outside of the encoded color pattern. The sharp luminance contrast between the light color outer boundary 113 and the dark encoded color border 111 provides a clear partition for extracting the region inside the light color outer boundary 113. The encoded color border comprises of a pattern of color blocks in colors selected from a combination of designated colors with high saturation and low lightness such as block 112a, 112b, 112c and 112d, which can be easily discriminated by the computing system.

Every color block with a designated color located one by one along the encoded color border represents a unit of the encoded data. The number of data bits of the color block depends on the number of colors used for configuring the color block. For a set of 4 designated colors, each color block can encode 2 bits of data. For example, color 1 encodes data of 00, color 2 encodes data of 01, color 3 encodes data of 10 and color 4 encodes data of 11. And for a set of 8 designated colors, the combinations of each color block can encode 3 bits of data. Through decoding the pattern of the encoded color border, the object identity of the encoded color patterns can be deducted.

In order to distinguish the orientation of the encoded color pattern, one side or part of a side of the encoded color border 111 is configured as an orientation reference pattern 112. In one embodiment of the present invention, all or a certain combination of color blocks 112a, 112b, 112c and 112d, which are located on one side of the encoded color border, form an orientation reference pattern 112 having a unique color pattern that no other sides of the encoded color border 111 has. The rest of the color blocks of the encoded color border 111 are used for encoding data of identity of the encoded color pattern.

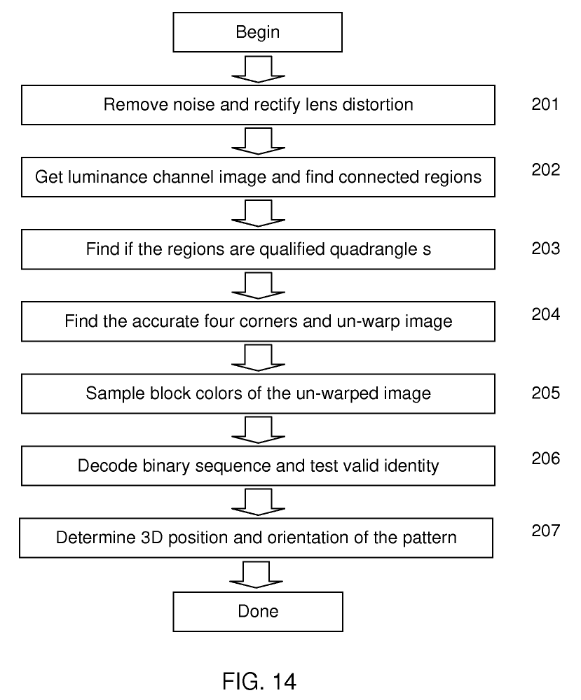

In one embodiment, the color blocks are arranged in a sequence from top to bottom and left to right for encoding data. For a 16-block encoded color pattern with 4 designated colors, 4 blocks on the top side 112a, 112b, 112c and 112d, are used for detecting the orientation. There are 12 blocks left for encoding data. Hence the number of data bits of the pattern is 24. Through a method of image processing further described in detail in FIG. 14, the object identity and the 6-DOF orientation and coordinates of the encoded color pattern can be estimated.

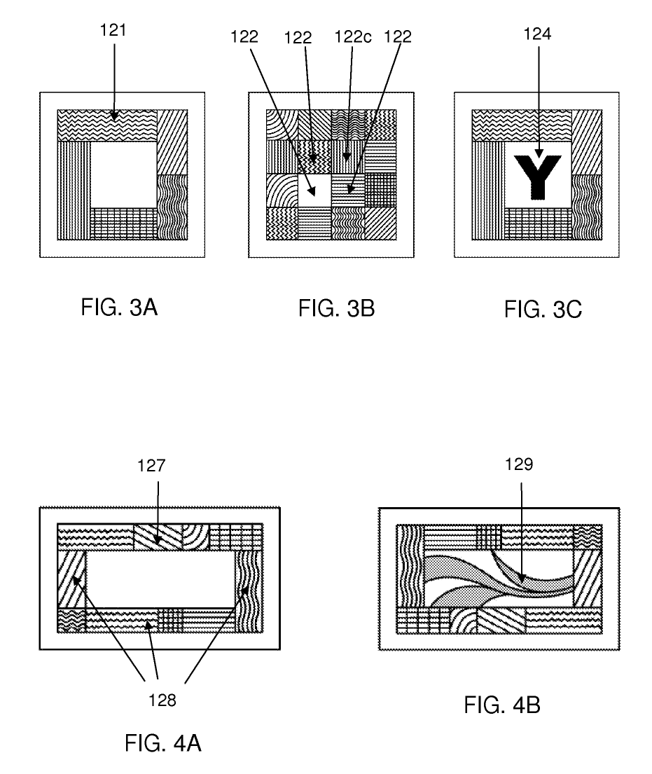

FIG. 3A is a diagram showing another embodiment of the encoded color pattern in square shape. Instead of dividing the encoded color border into small color blocks with similar size like FIG. 2, the encoded color border is configured with color blocks with a mixture of sizes. The color block 121 which is different in color from other color blocks, is defined as the orientation reference pattern of the encoded color border. The other part of the encoded color border is used for encoding the data of identity of the encoded color pattern.

FIG. 3B is a diagram showing another embodiment of encoded color pattern in square shape. The inner region 110 in FIG. 2 is now configured with color blocks 122a, 122b, 122c and 122d. Some of blocks in the inner region can be in white color such as block 122a. Since the blocks are encoded with binary data, the number of data bits is increased as more color blocks can be configured in the encoded color pattern. In this embodiment, all or a certain combination of blocks 122a, 122b, 122c and 122d in the inner region are used to form the orientation reference pattern of the encoded color pattern. The rest of blocks 122a, 122b, 122c and 122d are used for encoding data of identity of the encoded color pattern.

FIG. 3C is a diagram showing another embodiment of encoded color pattern in square shape. The inner region 110 in FIG. 2 is configured with a unique pattern, which is used for orientation detection of the encoded color pattern through a method of template matching.

The configurations of the orientation reference pattern are not limited to the illustrations in FIG. 3A, FIG. 3B and FIG. 3C. Other configurations can be used in condition that the orientation reference pattern should be uniquely configured in the encoded color pattern.

FIG. 4A is a diagram showing yet another embodiment of encoded color pattern in rectangle shape. The orientation reference pattern is block 127 and other sides 128 are used for encoding data.

FIG. 4B is a diagram showing another embodiment of encoded color pattern in rectangle shape. A highly decorative inner pattern 129 is used for orientation detection of the encoded color pattern through a method of template matching. The encoded color border is used for encoding data.

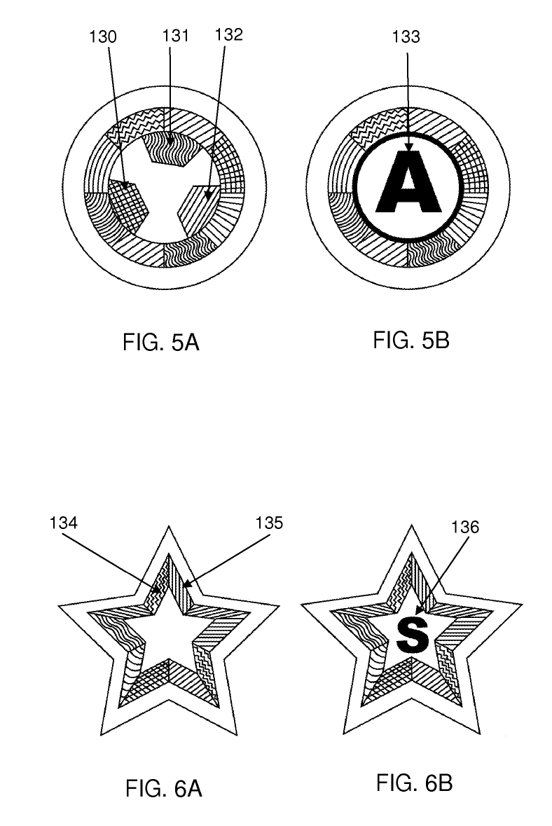

FIG. 5A is a diagram showing yet another embodiment of encoded color pattern in circle shape. An encoded color pattern is configured with an outer encoded color border and an inner encoded color region. The inner encoded color region with color blocks 130, 131 and 132 forms an orientation reference pattern, while the outer encoded color border is used for encoding data.

FIG. 5B is a diagram showing another embodiment of encoded color pattern in circle shape. An encoded color pattern is configured with an outer encoded color border and an inner pattern 133. The inner pattern 133 is used for orientation detection of the encoded color pattern through a method of template matching, while the rest of encoded color border is used for encoding data.

FIG. 6A is a diagram showing yet another embodiment of encoded color pattern in star shape. An encoded color pattern is configured with an encoded color border. The color blocks 134 and 135 forms an orientation reference pattern, while the rest of encoded color border is used for encoding data.

FIG. 6B is a diagram showing another embodiment of encoded color pattern in star shape. An encoded color pattern is configured with an outer encoded color border and an inner pattern 136. The inner pattern 136 is used for orientation detection of the encoded color pattern through a method of template matching, while the outer encoded color border is used for encoding data.

One who is skilled in the art knows that the shape of the encoded color pattern is not limited to the above-mentioned shapes for the encoded color border. Any geometrical shapes capable of being un-warped can be used for configuring the encoded color pattern.

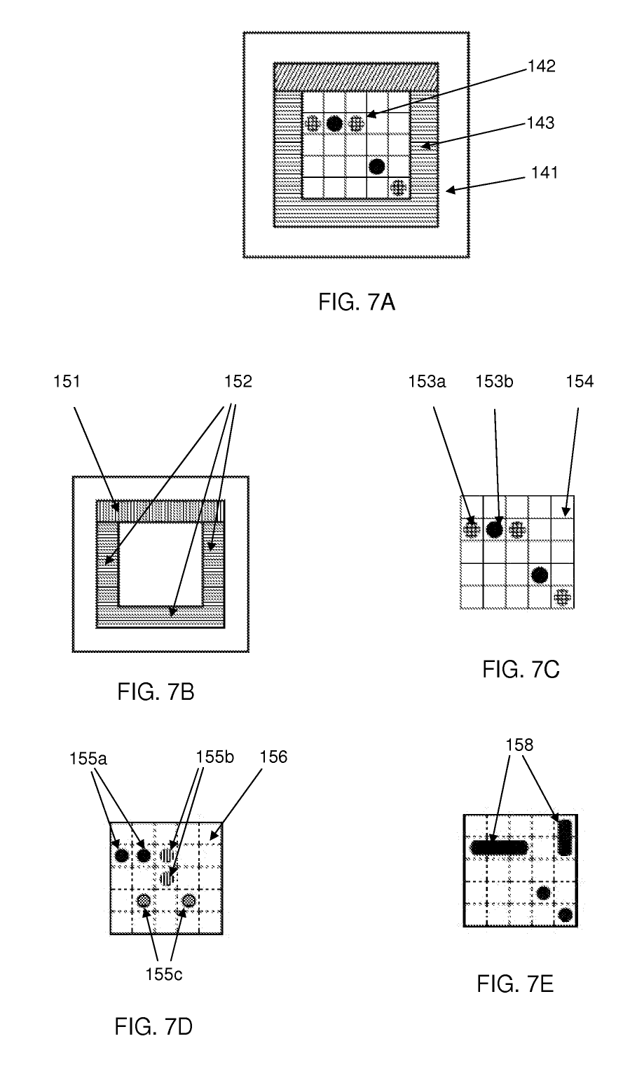

FIG. 7A is a diagram showing the encoded color pattern of yet another embodiment where the data of the object identity is encoded in the inner region, while the encoded color border is only uses for orientation detection. The encoded color pattern is in shape of a square, comprising an outer boundary 141 in colors of high lightness, an encoded color border 143 in colors of high saturation and low lightness, and an inner encoded pattern 142 in colors of high saturation and low lightness in order to contrast with the light color background.

FIG. 7B is a diagram showing the encoded color border of the encoded color pattern of FIG. 7A. One side of the square border is in one color 151 and the other three sides are in color 152. This encoded color border forms an orientation reference pattern. The two colors 151 and 152 are preferably complementary to each other, so the hue distance between them is maximal. The low luminance values of the colors are chosen because they have a sharp contrast to the light color outer boundary.

FIG. 7C is a diagram showing the inner encoded pattern of the encoded color pattern of FIG. 7A. The inner encoded pattern is a grid of cells filled with a pattern of color blocks. Each cell is painted with one of the designated colors 153a and 153b or just left empty 154. The designated colors 153a and 153b of the cells are chosen to be low luminance and the hue channel is complementary to each other. Only two designated colors 153a and 153b are used in order to maximize the distances between the colors. Every cell represents a unit of the encoded data. In one embodiment, a cell with color block in any of the two designated color 153a and 153b or just empty 154 composes one bit of data.

FIG. 7D is another diagram showing a variation of the inner encoded pattern of FIG. 7C. Three well-contrasted colors are chosen for the designated colors 155a, 155b, 155c. In this embodiment, the three designated colors 155a, 155b, 155c, and an empty cell 156, composes two bits of data.

FIG. 7E is another diagram showing a variation of the inner encoded pattern of FIG. 7C. The shape of the pattern in the cells is not limited to small blocks. Other shapes that are symmetrical in shape 158 or with the centroid located at the middle of the cell can be used.

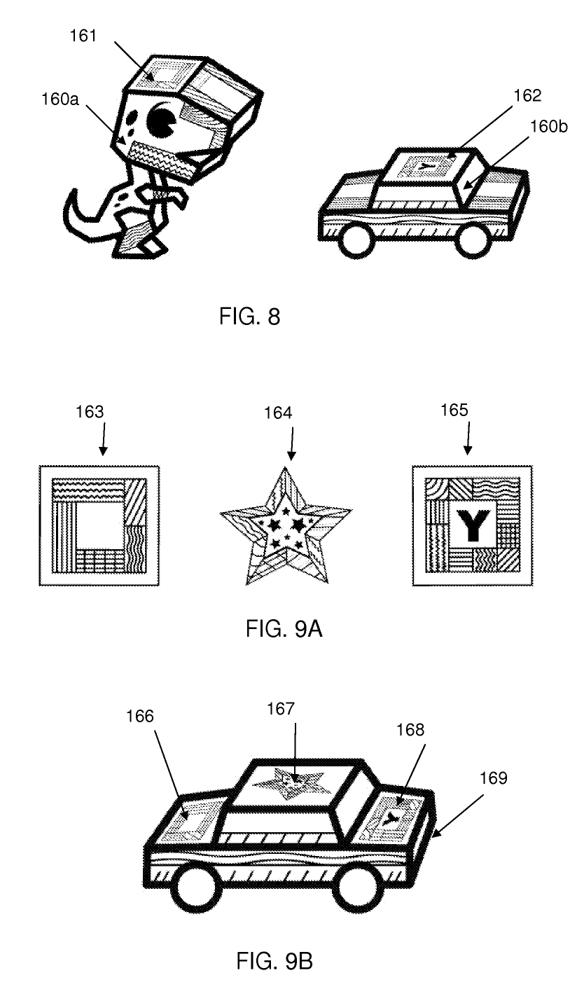

FIG. 8 is a schematic view showing encoded color patterns integrated with the color surfaces of tangible objects. The encoded color patterns 161 and 162 are configured on the top area of a toy dinosaur 160 a and a toy car 160b respectively. Since the tracking system of the present invention allows a certain degree of freedom in design the color and pattern of the encoded color pattern, the encoded color patterns 161 and 162 is integrated into the decoration on the surface of the tangible toys. The surface of the tangible toy or tangible input object becomes an encoded color surface. The identity of the tangible toy or tangible input object within a field of sight of an image capturing device is capable of being deduced by a computing system.

FIG. 9A is a diagram showing an encoded color pattern comprised of three encoded color patterns 163, 164 and 165. The configuration with multiple encoded color patterns is capable of reducing the problem of occlusion as every encoded color pattern carries the similar object identity. The combination of encoded color patterns provides a more complex input mechanism for triggering complex input commands at a program running on a computing system. The combination of patterns also allows more freedom in configuring the encoded color surface.

FIG. 9B is a schematic view of a toy car 169 configured with color patterns shown in FIG. 9A. The use of multiple encoded color patterns 166, 167 and 168 on an object surface can also avoid occlusion which causes the tracking system fails to detect the tangible object configured with only one encoded color pattern.

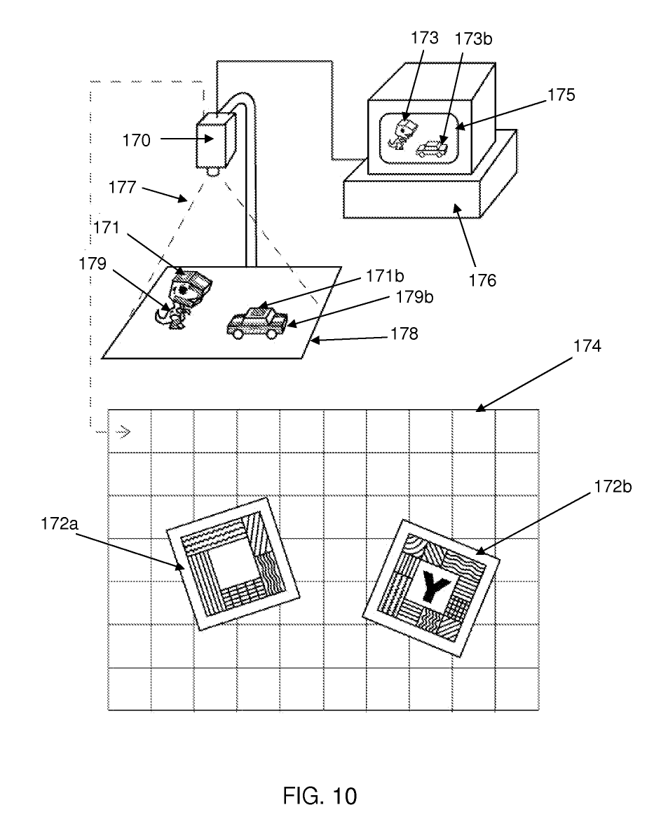

FIG. 10 is a schematic view of the tracking system which detects and tracks the encoded color patterns on tangible toys and tangible input objects through an image capturing device 170 in accordance with one embodiment of the present invention. The image capturing device 170 monitors a field of sight 177 through which the encoded color patterns 171a and 171b are detected. The tangible objects, a toy dinosaur 179a configured with encoded color pattern 171a and a toy car 179b configured with encoded color pattern 171b, are thus capable of being detected when the encoded color pattern 171a and 171b are placed within the field of sight 177 of an image capturing device 170.

The encoded color patterns 171a and 171b are now associated with the toy dinosaur 179a and the toy car 179b respectively. The grid 174 is a digitized screen of the image capturing device 170, corresponding to the plane 178 with which the encoded color patterns 171a and 171b are captured. The screen resolution of the grid 174 is associated with the resolution of the image capturing device 170. In the captured image 174, the encoded color pattern 172a corresponds to the toy dinosaur 179a with encoded color pattern 171a while the encoded color pattern 172b corresponds to the toy car 179b with encoded color pattern 171b. The other region of the image is the background image on the plane 178.

Through a decoding process described in detail in FIG. 14, the image capturing device 170 is capable of identifying the identities and tracking the 6-DOF orientations and coordinates of encoded color patterns 172a and 172b. The 6-DOF orientations and coordinates of the encoded color patterns 172a and 172b in the grid 174 are set to correspond respectively to the 6-DOF orientations and coordinates of the encoded color patterns 171a configured on the toy dinosaur 179a and 171b on the toy car 179b. When the user moves the toy dinosaur 179a or the toy car 179b, the orientations and coordinates of the encoded color patterns 172a and 172b in the grid 174 will be changed accordingly. In one embodiment, the information of identities, orientations and coordinates are passed to the computing system as input commands. The information of the 6-DOF orientations and coordinates of encoded color patterns 172a and 172b are used to control the 6-DOF orientations and coordinates of the virtual objects 173a (a virtual dinosaur) and 173b (a virtual car) displaying in the display system 175. Hence, the tangible toy dinosaur 179a and toy car 179b are transformed into tangible input devices for triggering input commands to a program running on a computing system 176.

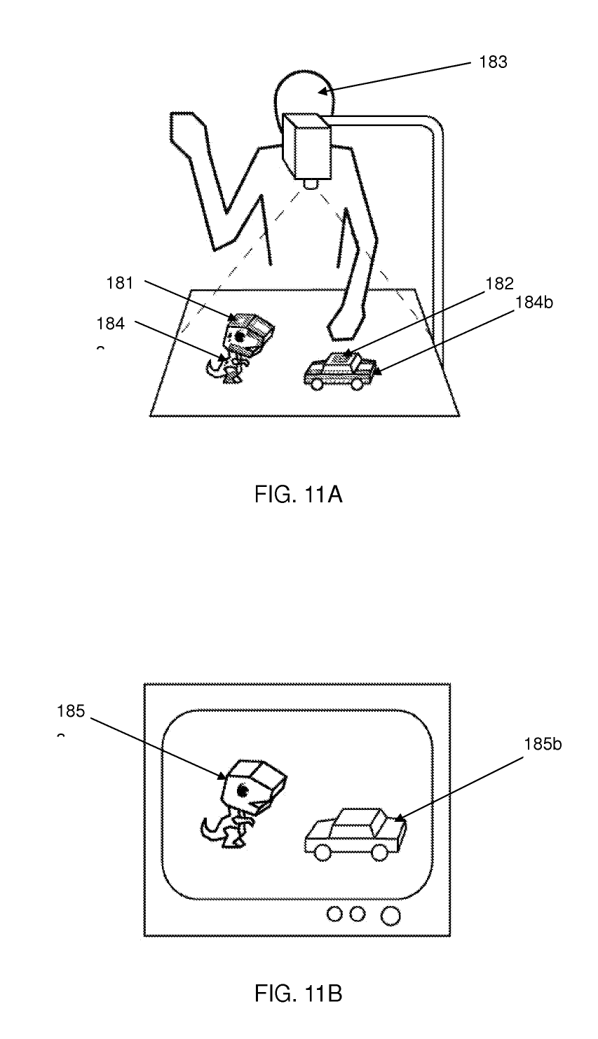

FIG. 11A is a schematic view showing a user 183 using the apparatus. In one embodiment, a tangible toy dinosaur 184a and a tangible toy car 184b with encoded color patterns 181 and 182 respectively are used as tangible input devices for a computing program running on a computing system. The user 183 can control the virtual dinosaur 185a and the virtual car 185b in the display system through manipulating the real world toy dinosaur 185a and the toy car 185b. FIG. 11B is a schematic view showing the real-time result displaying on the screen of the computing system.

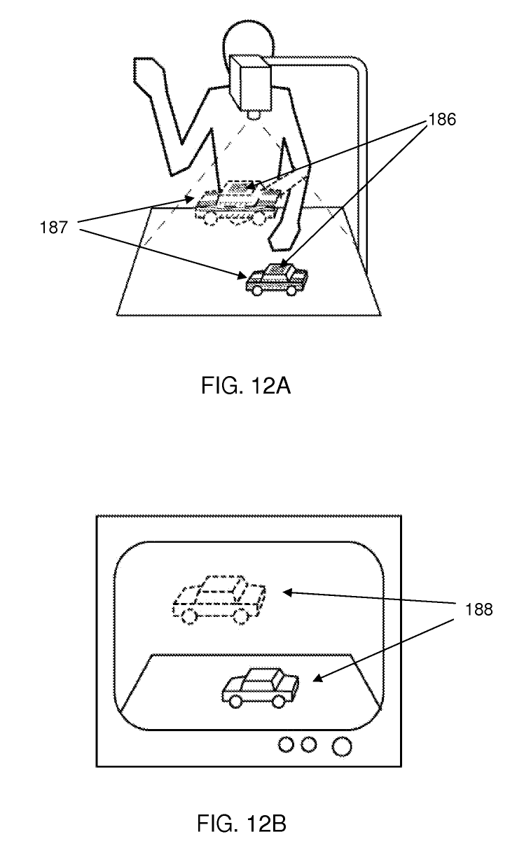

FIG. 12A is a schematic view showing a user is moving upward a toy car 187 with encoded color pattern 186. FIG. 12B is a schematic view showing the real-time result displaying in computing system that the corresponding virtual car 188 is moving upward. This also shows the tracking system of the present invention is a 3-dimensional tracking system.

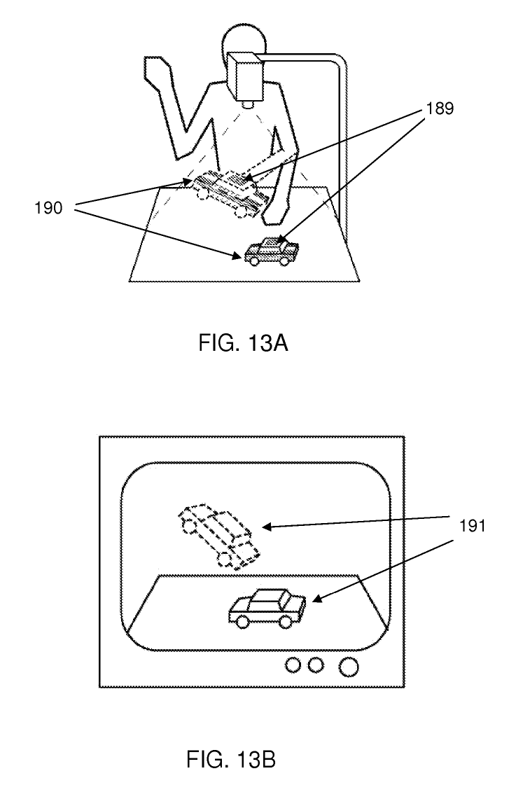

FIG. 13A is a schematic view showing a user is tilting the toy car 190 with encoded color pattern 189. FIG. 13B is a schematic view showing the real-time result displaying in computing system that the corresponding virtual car 191 is tilting. This also shows the tracking system of the present invention is a 3-dimensional tracking system.

FIG. 14 is a flow chart diagram showing the method of detecting and tracking an encoded color pattern in shape of a quadrangle. The acquired 2-dimensional image from the image capturing device is being processed through a series of image processing steps to find the encoded identity of the encoded color pattern. Once an encoded color pattern image is identified, the 6-DOF orientation and coordinates of the encoded color pattern is estimated.

The method initiates with operation 201 to remove the noise of the image caused by the camera sensor and rectify the distortion of the image caused by the lens of camera. The camera needs to go through a calibration process to obtain the implicit camera parameters in advance. These parameters are used for rectifying the distortion caused by the lens. The implicit camera parameters of a specific lens of the camera can be measured known methods, for example the method suggested by Heikkl et al [Ref 1, below]. The image is processed by a Gaussian smoothing filter to remove noise caused by the camera sensor, and then the implicit parameters is used to correct the distortion of the image.

The method then moves to operation 202 to get the luminance channel of the color image and find the connected regions. The captured RGB image is converted into HLS (Hue, Luminance, Saturation) image. The luminance channel of the image is extracted and processed through a local adaptive thresholding method where each pixel is thresholded by the arithmetic mean of the 3×3 neighboring pixels. The result is a bi-level image which shows the connected regions.

The method then moves to operation 203 to find the connected regions that are qualified quadrangles. The connected regions are approximated to produce simple polygons. In this embodiment, the approximation is done by the Douglas-Peucker algorithm and quadrangles are selected from the approximated polygons. The quadrangles are further selected by the prescribed range of perimeters and inner angles of the quadrangles.

The method then moves to operation 204 to find the more accurate positions of the corners of the quadrangles and un-warp the images included by the four corners into images of potential encoded color pattern. In one embodiment, on each edge of an approximated quadrangle region, 8 equally-distant pixel points on the edge are fitted by least-squares method to get a line. The intersections of the four lines are the more accurate corner positions of the quadrangle region. The HLS image inside quadrangle region is un-warped into a square image by perspective transformation. The result is a set of potential encoded color pattern images and they are further processed to test the identities of the encoded data in the pattern.

The method then moves to operation 205 to sample the blocks on each potential encoded color pattern image according to the prescribed pattern of shape and colors. In the embodiment of a square shape, the HLS image of each potential encoded color pattern image is sub-divided into 16 blocks. The pixels of each block are processed with a ID hue color histogram, where the histograms bins are the predefined hue range of colors of the encoded color pattern. The highest bin color means the true hue color of the block.

The method then moves to operation 206 to find a valid orientation reference pattern from the encoded color pattern and deduce the identity of the encoded color pattern. The blocks in the four sides of the encoded color border are tested against the designated configuration of the orientation reference pattern. The configuration can be the whole side of border or any other configurations of blocks that can be used to identify the unique orientation, as described in FIG. 3A to 3C, 7B. The other color blocks are transformed into a sequence of binary code according to the deducted orientation and the prescribed order in encoding. The binary code is then tested by a prescribed error checking function. The identity of a marker is resulted if the binary code is decoded correctly. In current embodiment, the binary code is checked against the prescribed Cyclic Redundancy Check (CRC) function.

The method then moves to operation 207 where the 2-dimensional corner positions of the quadrangle in operation 204 are used to compute the 6-DOF orientation and coordinates of the encoded color pattern, using known pose estimation algorithms for single camera computer vision such for example as those described by Quan et al [Ref 2, below] or Oberkampf et al [Ref 3, below]. The orientation and coordinates are estimated with reference to the camera image center.

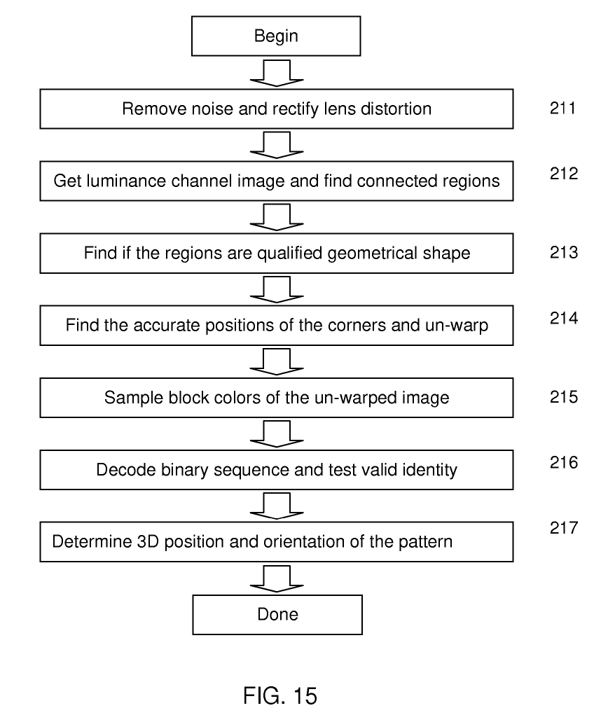

FIG. 15 is a flow chart diagram showing the method of detecting and tracking encoded color patterns in other geometrical shapes. The steps of image processing are similar to FIG. 14, except operation 213 is to find the connected regions that are qualified geometrical shape.

To summarize, the present invention provides a video image based tracking method and apparatus for identifying and tracking encoded color surface on tangible objects such as tangible toys or tangible input objects so that they are capable of acting as 6-DOF multi-input tangible input devices to trigger input commands to a program running on a computing system to control virtual objects and trigger game interactions.

Aesthetically, encoded color patterns can be integrated into the color and pattern design on the surface of the tangible objects. Technically, there are a number of advantages with the method of using encoded color pattern in this invention. Firstly, the color pattern has tremendously increased the number of data carried in an encoded color pattern. Secondly, the encoded color border reduces the false negative rate of a valid encoded color pattern as irrelevant pattern regions are pruned away at earlier stage. Thirdly, the identity of the encoded color pattern is encoded by a cyclic redundancy check function which provides a fiducially correct encoded color pattern. Fourthly, direct decoding of the pattern is used rather than using template matching of an image database. Hence, the entropy of an encoded pattern is more robust to determine the identity of an encoded color pattern in a natural environment. Moreover, a great number of encoded color patterns can be configured thus a huge number of tangible input devices can be generated.

In one useful embodiment of the method of the invention, the encoded color pattern is a color pattern in shape of a square, the outer boundary is white, a combination of four colors with contrasting hues is used for determining the encoded data in the inner region, the encoded color border is configured with one side in blue color and all other sides in red color to form the orientation reference pattern and a combination of color blocks with high saturation is configured in the inner region to provide encoding data of the identity of the encoded color pattern. In addition, each color block of the four designated colors can be transformed into two-bit binary code and the encoded color pattern can be configured on the top of the tangible object so as to minimize occlusion within the field of sight of an image capturing device positioned above the object.

The method for identifying encoded color patterns and estimating 6-degree-of-freedom orientations and coordinates of the encoded color pattern within the field of sight of an image capturing device can comprise:

a) using a 3×3 Gaussian smoothing filter for removing the noise of the image caused by the camera sensor;

b) using a set of prescribed implicit parameters for a specific lens of the camera, the implicit parameters including a multi-step camera calibration procedure for implicit image correction by the method of Heikkl et al, for rectifying image distortion caused by the lens of the camera;

c) Converting the captured RGB (Red, Green Blue) image into a HLS (Hue, Luminance, Saturation) image;

d) Finding connected regions, including the steps of:

processing a luminance image through a local adaptive thresholding method wherein each pixel is thresholded by the arithmetic mean of the 3×3 neighboring pixels;

approximating the connected regions using the Douglas-Peucker algorithm to produce simple polygons; and selecting a quadrangle to comply with a prescribed range of perimeters and inner angles;

e) Finding the corner positions of the quadrangle, including the steps of fitting eight equally-distant pixel points along each edge of the quadrangle to form a line by a least squares method; and finding the accurate corner positions from the intersections of the four fitted lines of the edges;

f) Un-warping the quadrangle image included by the four corners into a square or rectangular image by perspective transformation in order to obtain the image of a potential encoded color pattern;

g) Sampling color blocks in the potential encoded color pattern images according to the designated pattern of shape and colors, including the steps of sub-dividing the HLS (Hue, Luminance, Saturation) image of the potential encoded color pattern into sixteen blocks, processing the pixels of each color block with a one-dimensional hue color histogram and finding the highest bin color corresponding with the true hue color of the color block;

h) Testing the color blocks in the four sides of the encoded color border against the designated configuration of an orientation reference pattern in order to find a valid orientation reference pattern from an encoded color pattern;

i) Deducing the identity of the encoded color pattern, including the steps of:

transforming the color blocks of the encoded color pattern, other than those belonging to the orientation reference pattern, into a sequence of binary code according to the deduced orientation and the prescribed order in encoding, each color block of the four designated colors being transformed into two-bit binary code;

concatenating the two-bit binary codes of the color blocks into an orderly sequence of binary code; and

obtaining the identity of the encoded color pattern by testing the binary code against a cyclic redundancy check function; and

j) Estimating the six degrees-of-freedom orientations and coordinates of the encoded color pattern from the two-dimensional corner positions of the quadrangle, using a Linear N-Point Camera Pose Determination such as that by Quan et al.;

or any suitable combination of two or more of the foregoing steps.

Disclosures Incorporated. The entire disclosure of each and every United States patent and patent application, each foreign and international patent publication, of each other publication and of each unpublished patent application that is specifically referenced in this specification is hereby incorporated by reference herein, in its entirety.

The foregoing detailed description is to be read in light of and in combination with the preceding background and invention summary descriptions wherein partial or complete information regarding the best mode of practicing the invention, or regarding modifications, alternatives or useful embodiments of the invention may also be set forth or suggested, as will be apparent to one skilled in the art. Should there appear to be conflict between the meaning of a term as used in the written description of the invention in this specification and the usage in material incorporated by reference from another document, the meaning as used herein is intended to prevail.

While illustrative embodiments of the invention have been described above, it is, of course, understood that many and various modifications will be apparent to those of ordinary skill in the relevant art, or may become apparent as the art develops, in the light of the foregoing description. Such modifications are contemplated as being within the spirit and scope of the invention or inventions disclosed in this specification.
[Ref 1] J. Heikkl and O. Silvn. A four-step camera calibration procedure with implicit image correction, Computer Vision and Pattern Recognition, 1106-1113, 1997.
[Ref 2] L. Quan and Z. Lan. Linear N-Point Camera Pose Determination, IEEE Transaction on Pattern Analysis and Machine Intelligence, 21(7), July 1999.
[Ref 3] D. Oberkampf, D. F. DeMenthon, and L. S. Davis. Iterative pose estimation using coplanar feature points, Computer Vision and Image Understanding 63(3):495-511, May 1996.

What is claimed is:

1. A method of configuring an encoded color pattern on a tangible object, the encoded color pattern being capable of being detected and tracked by a computing system having an image capturing device, the method comprising applying to the tangible object with:
an outer boundary;
an encoded color border; and
an inner region;
wherein the encoded color border can be distinguished from the outer boundary.

2. The method of claim 1, wherein the encoded color pattern is a color pattern in shape of a square, or a geometrical shape capable of being un-warped.

3. The method of claim 1, wherein the encoded color pattern is configured with:
a) a white or light outer boundary providing a light color space between the encoded color border and the surrounding background;
b) an encoded color border comprising a pattern of blocks in colors selected from a designated combination of colors of high saturation and low lightness, wherein the colored blocks can be discriminated in the image captured by the image capturing device;
c) an inner region comprising a blank region, or a decorative color field of high lightness, or a color pattern with high saturation and low lightness, or a pattern of color blocks in colors selected from a designated combination of colors of high saturation, wherein the color pattern and colored blocks can be discriminated in the image captured by the image capturing device.

4. The method of claim 3, wherein each color block located along the encoded color border and inside the inner region represents a unit of the encoded data, and wherein the hue, intensity or saturation values of the colors are used for determining the encoded data.

5. The method of claim 3, wherein the encoded color border is configured with:
a) a combination of the contrasting color blocks located on one side, which has a unique color pattern that no other side of the encoded color border has; or
b) a combination of the contrasting color blocks located on any side, which has a unique color pattern that no other part of the encoded color border has; or
c) having one side in one complementary color and all other sides in another complementary color;
wherein the encoded color border forms an orientation reference pattern, wherein the orientation reference pattern is used for distinguishing the orientation of the encoded color pattern.

6. The method of claim 3, wherein the encoded color border is usable for providing encoding data of the identity of the encoded color pattern.

7. The method of claim 3, wherein the inner region configured with a color pattern or a combination of color blocks forms an orientation reference pattern having a unique color pattern that no other part of the encoded color pattern has, and wherein the orientation reference pattern is usable for distinguishing the orientation of the encoded color pattern.

8. The method of claim 3, wherein the inner region configured with a color pattern or a combination of color blocks is usable for providing encoding data of the identity of the encoded color pattern.

9. A method for identifying encoded color patterns and estimating the six-degrees-of-freedom orientations and coordinates of an encoded color pattern within the field of sight of an image capturing device, the method comprising:
removing noise from the captured image caused by the image capturing device sensor;
rectifying the distortion of the image caused by the lens of the image capturing device;
getting the luminance channel of the color image;
finding connected regions;
finding the connected regions that are qualified quadrangles;
finding more accurate positions of the corners of each quadrangle;
un-warping the image included inside the four corners of each quadrangle to obtain the images of a potential encoded color pattern;
sampling the blocks in the potential encoded color pattern images according to a designated pattern of shape and colors;
finding the valid orientation reference pattern of the encoded color pattern;
deducing the identity of the encoded color pattern;
computing the six-degree-of-freedom orientation and coordinates of the encoded color pattern from the two-dimensional corner positions of the quadrangle.

10. The method of claim 9, implemented on a computer readable medium composing program instructions, or on a computing system, comprising a game console, a general-purpose computer, a networked computer, a distributed processing computer or an embedded system and wherein each logic element in the computing system comprises a hardware element, a software element, or a combination of hardware and software elements.

11. The method of claim 10, wherein the computing system comprising an image capturing device, wherein the image capturing device is a webcam, a digital camera, a camera coupled with a digitizer, or an array of charge coupled devices (CCDs), wherein the image capturing device is operable in a normal living environment, lighted by daylight or artificial light and wherever the computing system provides an automatic or manual calibration of the white balance by the image capturing device to adapt the image sensor to the color temperature of the light source.

12. A tangible input device useful for interfacing with a video image based tracking system and controlling the virtual objects of a computing program running on a computing system, the tangible input device comprising:
a tangible object; and
an encoded color pattern capable of being detected and tracked by a computing system having an image capturing device.

13. The tangible input device of claim 12, wherein the tangible object is a tangible toy or a tangible gaming object, wherein an encoded color pattern is configured on the surface of the tangible input device and integrated into the color and pattern of the design of the object surface wherein the encoded surface can be configured on any side of the tangible object capable of being detected by the computing system when it is placed within the field of sight of the image capturing device wherein, optionally, the encoded color pattern is configured on the top of the tangible object so as to minimize occlusion within the field of sight of an image capturing device positioned above the object.

14. The tangible input device of claim 12, wherein multiple tangible input devices with different encoded color patterns can be simultaneously detected and identified by a computing system.

15. The tangible input device of claim 12, wherein the identity of the encoded color pattern is associated with the identity of the tangible input device, and wherein the six-degrees-of-freedom orientations and coordinates of the encoded color pattern are associated with the six degrees of freedom orientations and coordinates of the tangible input device.

16. The tangible input device of claim 12, wherein the manipulation of the tangible input device, including the changing of its six degrees of freedom orientations and coordinates, the changing speed, acceleration and direction, the changing of its distance from other tangible or virtual objects, and the removal of the tangible input device from the field of sight of an image capturing device, provide a designated input mechanism for triggering designated input commands.
